(19) United States
(12) Patent Application Publication
(10) Pub. No.: US 2004/0231350 A1
(43) Pub. Date: Nov. 25, 2004

(54) Compact air conditioning mixer system

(76) Inventors: Erin Kline, Vernon, CT (US); Thomas Zywiak, Suffield, CT (US); Charles J. McColgan, West Granby Road, CT (US); Douglas Christians, Vernon, CT (US); William Lockwood, Enfield, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/442,510

(22) Filed: May 21, 2003

(51) Int. Cl. B60H 1/32; F25D 17/04; F25D 17/06

(52) U.S. Cl. 62/244; 62/415; 62/427

(57) ABSTRACT

An air conditioning system provides a pack conditioned air passage which intersects with a recirculation passage prior to communication of the combined air flow with a mixer. The combined air flow traverses a distance between the intersection between the pack conditioned air passage and the recirculation passage and an entry to the mixer which reduces the required volume of the mixer as compared to conventional systems.

### BACKGROUND OF THE INVENTION

The present invention relates to an apparatus and method for controlling the climate within a vehicle, and more particularly to a compact mix manifold air conditioning system.

Conventional air conditioning and heating systems supply a relatively constant flow of fresh air into the pressurized body of vehicles such as aircraft. Conventional air conditioning systems provide fresh air through air conditioning packs located in an unpressurized area of the aircraft. In order to maintain a relatively constant and comfortable temperature and humidity level of the ventilation air for the passengers and crew in the aircraft, recirculation air from the cabin area of the aircraft typically is mixed with fresh air within a mix manifold. The sub-freezing fresh air and recirculated cabin air are typically mixed in the relatively large mix manifold located in the pressurized compartment of the vehicle which disadvantageously reduces the amount of available pressurized space in the aircraft.

Accordingly, it is desirable to provide a mixer manifold that reduces the occupied space within a pressurized compartment.

### SUMMARY OF THE INVENTION

The air conditioning system according to the present invention provides a pack conditioned air passage which intersects with a recirculation passage prior to communication of the combined air flow with a mixer. The combined air flow traverses a distance between the intersection between the pack conditioned air passage and the recirculation passage and an entry to the mixer. The additional distance within the passage in which the air flows are combined provides for a reduction in the mixer volume as compared to conventional systems.

Another air conditioning system provides a direct mixed passage which intersects the recirculation passage between the intersection of the pack conditioned air passage and the recirculation passage and the entry to the mixer. The direct mixed passage provides a relatively colder airflow to cool avionics or the like. Another direct mixed passage selectively communicates with the mixer through interconnecting passages and valves to provide further temperature control within the aircraft.

The present invention therefore obviates the requirement for a large mix manifold and associated ducting present in conventional systems thereby reducing weight and noise.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic diagram of an aircraft air conditioning system according to the present invention;

FIG. 2 is a perspective view of an air conditioning system passage arrangement having a relatively compact mixer chamber;

FIG. 3 is a perspective view of an internal vane arrangement between an airflow intersection of the air conditioning system passage arrangement according to the present invention; and

FIG. 4 is a schematic diagram of an aircraft air conditioning system according to the present invention.

### DETAILED DESCRIPTION OF THE PREFERRED EMBODIMENT

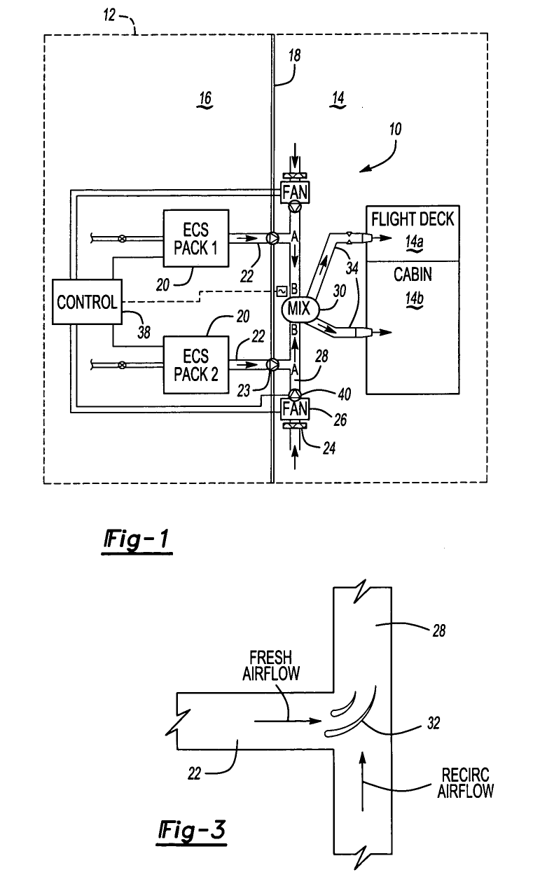

FIG. 1 illustrates a general schematic view of an air conditioning system 10 for a vehicle such as an aircraft (illustrated schematically at 12) having a pressurized area 14 and an unpressurized area 16 with a pressure bulkhead 18 therebetween. The air conditioning system 10 is particularly advantageous for use in commercial airplanes that operate at high altitudes. However, the air conditioning system can have other forms and be used in other applications, such as in pressurized ground vehicles and enclosures. Although the system 10 is shown as a singular unit, the system may be designed such that separate systems are provided for individual zones within the pressurized area 14 for the vehicle flight deck 14a and the vehicle cabin 14b. As such, separate temperatures may be maintained for each zone to ensure comfort and efficiency.

Fresh air is provided by fresh air treatment hardware, such as air conditioning packs 20, located in the unpressurized area 16. Air may be provided to the air conditioning pack 20 from various sources such as, for example only, the compressor of a gas turbine engine, or an auxiliary power unit, such that relatively high temperature, high pressure air is supplied to the air conditioning pack for treatment. Air from the packs 20 is communicated through the bulkhead 18 within a pack conditioned air passage 22.

A check valve 23 or the like in line with the pack conditioned air passage 22 preferably protects against depressurization of the pressurized compartment due to a rupture in the pack conditioned air passage 22 in the unpressurized area 16.

Recirculation air from the pressurized compartment 14, such as the vehicle flight deck 14a, the vehicle cabin 14b and/or selected cargo areas, is processed through a filter 24 and a fan 26 located within a recirculation passage 28. Although the fan 26 is located within the pressurized area 14 of the illustrated embodiment, it should be understood that the fan may be located in the unpressurized area 16 to allow easier maintenance access and to reduce fan noise transmission to the cabin.

Notably, the pack conditioned air passage 22 intersects with the recirculation passage 28 prior to communication of the combined air flow with a mixer 30. The combined air flow traverses a distance between the intersection between the pack conditioned air passage 22 and the recirculation passage 28 (point A) and an entry (point B) to the mixer 30. The combined airflow is mixed along the distance A-B which provides for a reduction in the volume of the mixer 30 as compared to conventional systems. That is, distance A-B essentially adds to the volume of the mixer 30.

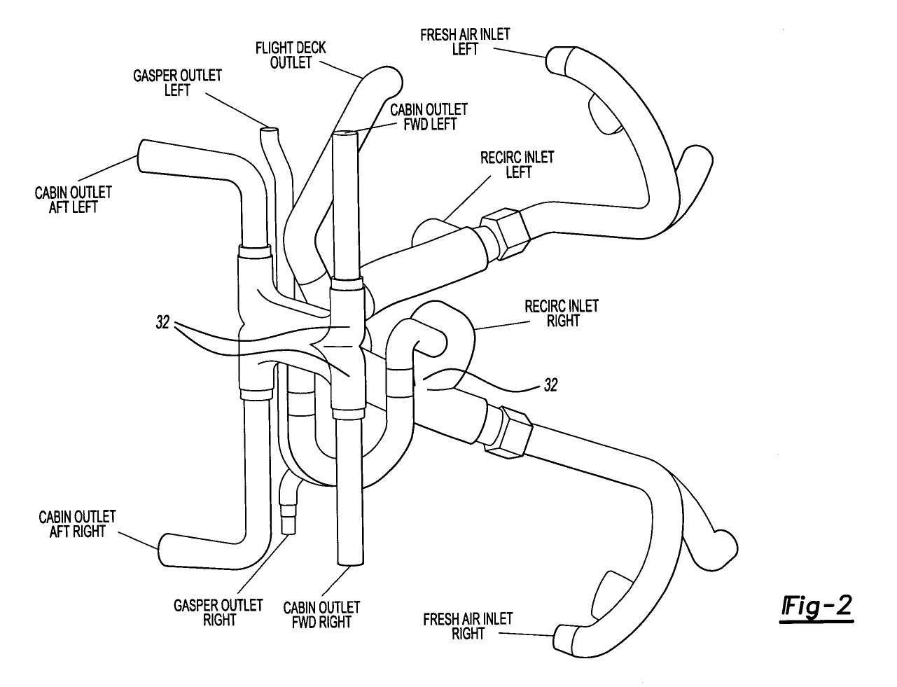

The present invention obviates the need for a large mix manifold and associated ducting present in conventional systems. It should be understood that although the passages are illustrated schematically in FIG. 1 as relatively straight, in actuality the passages may be of a serpentine arrangement (FIG. 2) for location within a relatively small packaging space typical of aircraft.

Preferably, internal vanes 32 (FIG. 3) are located in the recirculation passage 28 (point A) to assure proper mixing of the recirculation air flows and the fresh air flows. The internal vanes 32 preferably swirl the recirculation air flow and the fresh air flow to initiate mixing prior to entry into the mixer 30. It should be understood that vanes of various designs will benefit from the present invention.

From the mixer 30, mixed airflow is communicated to the vehicle flight deck 14a and the vehicle cabin 14b through delivery passages 34 so as to maintain airflow at a desired temperature without generating a fog, snow, or water in the aircraft. The mixed resultant air flow preferably is of a temperature that is sufficiently high such that the ice particles are substantially eliminated.

The air temperature and flow are monitored and controlled by a controller 38. Although the controller 38 is depicted to be in the unpressurized area 16, the controller may be in the pressurized area 14. A sensor S is operatively connected to the mixer 30 and adapted for detecting conditions such temperature. The controller 38 is operatively connected with and controls the pack 20 and fan 26 to maintain air flow in the pressurized area 14 according to a desired temperature setting. It should be understood that other valve arrangements and controls will benefit from the present invention whereby the status of the system 10 is constantly monitored and correspondingly controlled when the system is in operation.

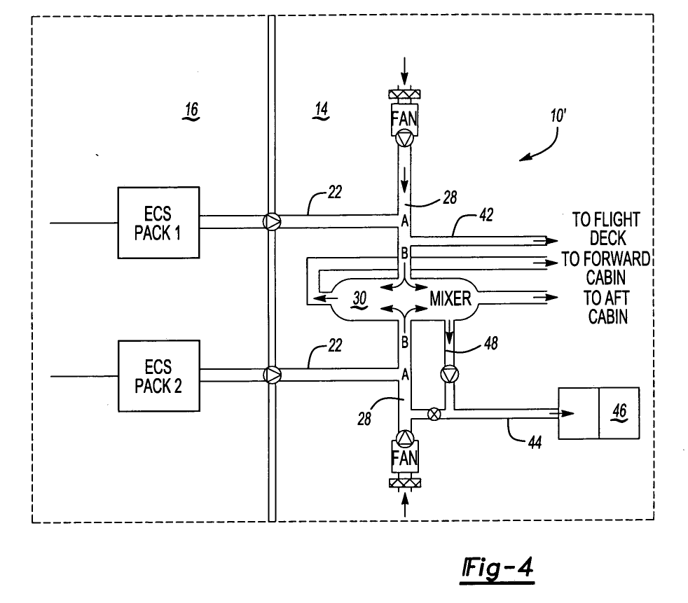

Referring to FIG. 4, a general schematic view of another air conditioning system 10′ is illustrated. System 10′ is as described above with an additional direct and cross-passage arrangement from the mixer 30.

A first direct mixed passage 42 intersects the recirculation passage 28 between the intersection of the pack conditioned air passage 22 and the recirculation passage 28 (point A) and the entry (point B) to the mixer 30. The direct mixed passage 42 preferably communicates direct to the flight deck without first being mixed in the mixer 30 to provide a relatively colder airflow to cool avionics or the like within the flight deck.

A second direct mixed passage 44 intersects the recirculation passage 28 between the intersection of the pack conditioned air passage 22 and the recirculation passage 28 (point A) and the entry (point B) to the mixer 30. The direct mixed passage 42 preferably communicates with a gasper system 46. An interconnecting passage 48 and valves 50 and 52 provides selective communication and airflow mixing between airflow within the second direct passage 44 and mixed airflow from the mixer 30 to provide further temperature control to the gasper system 46. As generally known, gasper system 46 provides localized control of airflow within the cabin.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason, the following claims should be studied to determine the true scope and content of this invention.

1. An air conditioning system comprising:
a mixer located within a pressurized area;
a recirculation passage in communication with said mixer to communicate recirculated air from said pressurized area to said mixer;
an air conditioning pack located within an unpressurized area; and
a pack conditioned air passage in direct communication with said air conditioning pack and said recirculation passage.

2. The system as recited in claim 1, wherein said mixer communicates mixed air to said pressurized area.

3. The system as recited in claim 1, wherein said mixer communicates mixed air to an aircraft flight deck.

4. The system as recited in claim 1, wherein said mixer communicates mixed air to an aircraft cabin.

5. The system as recited in claim 1, wherein said pack conditioned air passage communicates through a bulkhead between said pressurized and unpressurized area.

6. The system as recited in claim 1, further comprising a fan located within said recirculation passage.

7. The system as recited in claim 1, further comprising a filter located within said recirculation passage.

8. The system as recited in claim 1, further comprising a valve between said filter located within said recirculation passage.

9. The system as recited in claim 1, further comprising a direct mixed passage communicating with said recirculation passage, said direct mixed passage located between an intersection of said pack conditioned air passage and said recirculation passage and said mixer.

10. The system as recited in claim 9, further comprising an interconnecting passage in communication with said direct mixed passage and said mixer.

11. The system as recited in claim 10, further comprising a valve to provide selective communication between said interconnecting passage and said direct mixed. passage and said mixer.

12. The system as recited in claim 10, further comprising a valve upstream of an intersection between said interconnecting passage and said direct mixed passage.

13. The system as recited in claim 1, further comprising an internal vane adjacent said recirculation passage and said pack conditioned air passage.

14. A method of providing an air conditioned airflow within a vehicle comprising a pressurized and unpressurized area, said method comprising the steps of:
(1) communicating recirculated air from a pressurized area to a mixer; and
(2) communicating fresh air from an air conditioning pack in an unpressurized area with the recirculated air upstream of the mixer.

15. A method as recited in claim 14, further comprising the step of:
communicating a mixed airflow of the fresh airflow and the recirculated airflow upstream of the mixer to the pressurized area.

16. A method as recited in claim 15, further comprising the step of:
selectively communicating a mixed airflow downstream of the mixer with the mixed airflow upstream of the mixer.

17. The system as recited in claim 1, wherein said pack conditioned air passage intersects with said recirculation passage at an intersection.

18. The system as recited in claim 1, further comprising an internal vane located within said recirculation passage adjacent said intersection.

19. The system as recited in claim 1, wherein said pack conditioned air passage intersects said recirculation passage upstream of said mixer.

20. The system as recited in claim 1, wherein said recirculation passage directly communicates with said mixer such that a length of said recirculation passage forms a combined air flow passage which traverses a distance between the intersection between said pack conditioned air passage and said recirculation passage and an entry to said mixer.

21. A method as recited in claim 14, wherein said step (2) further comprising the step of:
swirling the recirculation air and the fresh air to initiate mixing prior to entry into the mixer.

22. A method as recited in claim 14, wherein said step (2) further comprising the step of:
directly communicating the recirculation air into the fresh air to initiate mixing prior to entry into the mixer.
